(19) United States
(12) Patent Application Publication
(10) Pub. No.: US 2013/0298886 A1
(43) Pub. Date: Nov. 14, 2013

(54) METHOD FOR CONTROL OF SPARK IGNITION IN SPARK-IGNITED INTERNAL COMBUSTION ENGINE

(71) Applicants: Takeshi Serizawa, Osaka (JP); Hiroaki Oi, Osaka (JP); Kazuhisa Taniguchi, Osaka (JP)

(72) Inventors: Takeshi Serizawa, Osaka (JP); Hiroaki Oi, Osaka (JP); Kazuhisa Taniguchi, Osaka (JP)

(73) Assignee: DAIHATSU MOTOR CO., LTD., Osaka (JP)

(21) Appl. No.: 13/981,121

(22) PCT Filed: Jan. 23, 2012
(86) PCT No.: PCT/JP2012/051286

§ 371 Date: Jul. 23, 2013

(30) Foreign Application Priority Data
Jan. 25, 2011 (JP) 2011-012776

(51) Int. Cl. F02P 15/00

(52) U.S. Cl. CPC F02P 15/00
USPC 123/594

(57) ABSTRACT

A method for control of spark ignition in a spark-ignited internal combustion engine that includes an ignition plug and generates plasma to ignite an air-fuel mixture, where the plasma is caused by a reaction between a product resulting from spark discharge generated by a high voltage applied via an ignition coil connected to the ignition plug and an electric field generated in a combustion chamber by an electric generation means via the ignition plug, the method including generating the electric field by a positive pulsating current. Thus, the method allows a spark-ignited internal combustion engine to promote expansion of combustion after ignition.

### TECHNICAL FIELD

The present invention relates to a method for control of spark ignition in a spark-ignited internal combustion engine that promotes combustion by plasma generation as a result of a reaction between an electric field generated in a combustion chamber and a product resulting from spark discharge by an ignition plug.

### BACKGROUND ART

Conventionally, for example, in an internal combustion engine for automobile, a high voltage is applied between a center electrode and a ground electrode of an ignition plug. An air-fuel mixture in the combustion chamber is ignited at each ignition timing by spark discharge generated at a gap between the both electrodes. Such ignition by the ignition plug may result in, for example, insufficient spark energy and thus hardly cause a flame core.

To solve such a problem with spark ignition, for example, Patent Document 1 describes generating plasma in a combustion chamber and causing a reaction between the plasma and the spark discharge to reliably form a flame core. In the description of Patent Document 1, a high-frequency electric field is formed immediately before spark discharge or at almost the same time as spark discharge by microwaves supplied via an ignition plug. Thus, the spark discharge and the plasma are reacted with each other to generate a stronger flame core.

In the case of using microwaves as disclosed in Patent Document 1, for example, a magnetron is employed as a source thereof. This tends to complicate a device for generating a high-frequency electric field. Under such circumstances, a high-frequency wave, which is lower in frequency than microwaves, may be used for a high-frequency electric field. In this case, for example, an attempt is made to apply to the ignition plug a pulsating voltage obtained by subjecting a high-frequency voltage to half-wave rectification by a diode. In this case, in an internal combustion engine mounted in an automobile, a negative high voltage is applied to the center electrode of the ignition plug to perform spark discharge. Thus, the pulsating voltage is also regarded as a negative voltage corresponding to spark discharge.

However, the plasma generated by a reaction between the product resulting from spark discharge and the electric field generated by a pulsating voltage contains plasma ions together with radicals such as OH radicals or ozone. After the ignition, therefore, radicals or positive ions are attracted to the electric field at the center of the ignition plug and near the ground electrode. Thus, the growth of a formed flame core becomes slow. Further, the diffusion of plasma is inhibited and thus the spread of combustion is suppressed. Consequently, the sufficient effect of promoting combustion by the plasma may not be exerted.

### CITATION LIST

### Patent Document

Patent Document 1: JP-A 2010-101182

### DISCLOSURE OF THE INVENTION

### Problems to be Solved by the Invention

Accordingly, an object of the present invention is to promote expansion of combustion after ignition.

### Solution to the Problem

Specifically, a method for control of spark ignition in a spark-ignited internal combustion engine according to one embodiment of the invention is a method for control of spark ignition in a spark-ignited internal combustion engine that includes an ignition plug and generates plasma to ignite an air-fuel mixture, where the plasma is caused by a reaction between a product resulting from spark discharge generated by a high voltage applied via an ignition coil connected to the ignition plug and an electric field generated in a combustion chamber by an electric generation means via the ignition plug. The method includes generating the electric field by a positive pulsating current.

With such a configuration, the electric field is generated by a positive pulsating current. This makes it possible to avoid that ions or the like as a product resulting from spark discharge gather near the ignition plug. As a result, the positive electric field and the product repel each other after the ignition. This expands combustion.

The pulsating current of the invention refers to a current and/or a voltage that flows in a constant direction and fluctuates in magnitude on a regular or irregular basis. Specifically, the positive pulsating current uses only a positive voltage obtained by subjecting a high-frequency wave to half-wave rectification or full-wave rectification without smoothing out the voltage. Alternatively, the positive pulsating current can be obtained by adding a direct positive voltage with the same value as the crest value of a high-frequency wave. In other words, the positive pulsating current can be obtained by biasing a high-frequency wave by a direct positive voltage with the same value as the crest value.

Other embodiments of the invention include a spark ignition control device that realizes the foregoing method for control of spark ignition, a spark ignition control program that causes a control device having a computer to execute the foregoing method, and a program product that includes media holding the program. The media include recording media such as ROM (read only memory) or transmission media such as communication lines.

### Effects of the Invention

The invention is configured as described above. With such a configuration, it is possible to suppress retention of a product resulting from spark discharge near an ignition plug. This makes it possible to promote expansion of combustion and improve fuel efficiency.

Objects, features, aspects, and advantages of the invention will be more apparent with the following detailed description and the attached drawings.

### BRIEF DESCRIPTION OF THE DRAWINGS

FIG. 1 is a cross-sectional diagram illustrating main components of an engine to which an embodiment of the present invention is applied.

FIG. 2 is a diagram illustrating an electric circuit of an ignition device according to the embodiment.

FIG. 3 is a flowchart illustrating a control process according to the embodiment.

### DESCRIPTION OF EMBODIMENTS

One embodiment of the present invention will be described below with reference to the drawings.

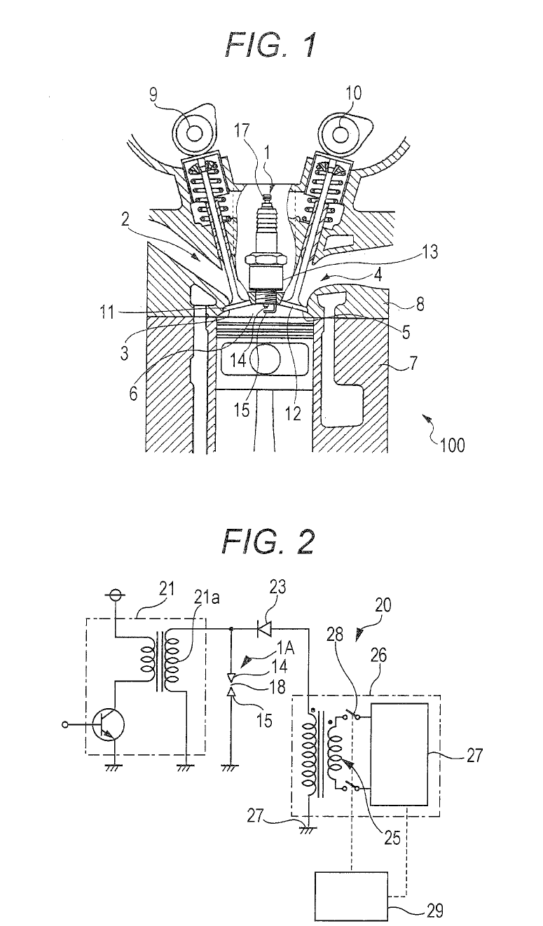

FIG. 1 illustrates a configuration of one cylinder of a two-cylinder engine 100, a spark-ignited internal combustion engine having an ignition plug 1. In the engine 100, an opening 3 of an intake port 2 and an opening 5 of an exhaust port 4 are symmetrically arranged with respect to the ignition plug 1. The ignition plug 1 is attached to almost the center of a ceiling part of a combustion chamber 6. Thus, each cylinder has two openings. That is, a cylinder head 8 of the engine 100 is attached to the cylinder block 7 and forms the ceiling part of the combustion chamber 6. The cylinder head 8 has a cam shaft 9 attached to the intake side and a cam shaft 10 attached to the exhaust side. The intake port 2 of the cylinder head 8 is opened and closed by an intake valve 11 that reciprocates by rotation of the cam shaft 9. The exhaust port 4 is opened and closed by an exhaust valve 12 that reciprocates by rotation of the cam shaft 10. The ignition plug 1 is attached to the ceiling part of the combustion chamber 6. The intake port 2 includes a fuel injection valve for generating an-air-fuel mixture to be supplied to the combustion chamber 6. The engine 100 may use a spark-ignited engine known in the art.

The ignition plug 1 according to the embodiment basically includes a housing 13 made of an electrically conductive material, a center electrode 14, a ground electrode 15, an ignition coil 21 with built-in igniter, and a connection terminal 17. The center electrode 14 is attached in the housing 13 in an insulated manner. The ground electrode 15 is provided at a lower end of the housing 13 to be separated from the center electrode 14 by a gap 14 in which spark discharge is generated. In the ignition coil 21 with built-in igniter (hereinafter simply referred to as an ignition coil), the igniter and the ignition coil are structurally integrated. The ignition coil 21 is electrically connected to the connection terminal 17. A plug well known in the art may be used as the ignition plug 1.

As illustrated in FIG. 2, the ignition device 20 connected to the ignition plug 1 includes the ignition coil 21, a diode 23, and a high-frequency voltage generator 26. The ignition coil 21 is connected to the ignition plug 1 in the first cylinder. The diode 23 has a cathode connected to a secondary winding wire 21a of the ignition coil 21. The high-frequency voltage generator 26 serves as an electric field generation means. That is, the high-frequency voltage generator 26 generates a positive electric field in the combustion chamber 6, in particular, in a region of the ignition plug 1 with the center electrode 14 centered. Such a high-frequency voltage generator 26 includes a step-up transformer 25 arranged at an output stage thereof, a generator main unit 27 connected to the step-up transformer 25, and a switching means 28. The switching means 28 controls a time (timing) for applying a voltage based on a high-frequency wave to the ignition plug 1. The switching means 28 is controlled by an electronic controller 29 such that, when it is determined that induction discharge is started, a high-frequency voltage is applied to the ignition plug 1.

The generator main unit 27 of the high-frequency voltage generator 26 is configured, for example, to raise a voltage of a vehicle battery (for example, about 12 volts (V)) by a DC-DC converter as a step-up circuit to 300 to 500V and to change a direct current raised in voltage by an H bridge circuit into an alternating current with a frequency from about 200 to 600 kHz. Thus, the high-frequency voltage generator 26 is configured to output a high-frequency wave increased in voltage to about 4 to 8 kVp-p from the step-up transformer 25.

The diode 23 serves as a rectifier means for a high-frequency wave (alternating current) generated by the high-frequency voltage generator 26 and also serves as a backflow prevention diode for a high voltage for spark discharge generated by the ignition coil 21. In other words, in the embodiment, at ignition in the combustion stroke, a positive high voltage is applied from the secondary winding wire 21a of the ignition coil 21 to the center electrode 14 of the ignition plug 1. Thus, the cathode of the diode 23 is connected to the corresponding secondary winding wire 21a. A positive high voltage can be therefore prevented from flowing back to the high-frequency voltage generator 26.

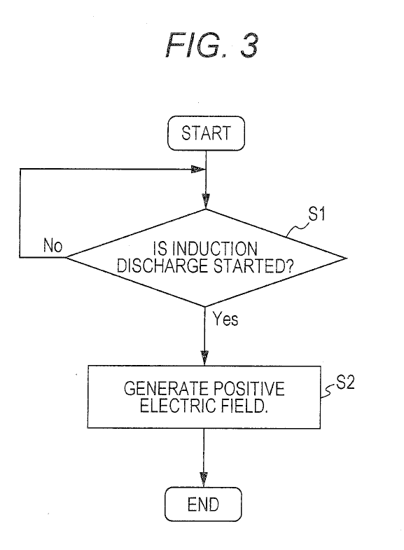

The electronic controller 29 contains an operation control program. The operation control program is used to control the operating state of the engine 100 in response to signals output from various sensors attached to the engine 100. In addition, the electronic controller 29 contains an ignition control program for spark ignition. The ignition control program is used to determine whether induction discharge is started in spark discharge, and output a positive high-frequency voltage when it is determined that induction discharge is started. FIG. 3 illustrates a process of control in the ignition control program.

In FIG. 3, it is determined at step S1 whether induction discharge is started. Specifically, when spark ignition is started, a capacitive spark is first generated by capacitive discharge, and then an induction spark is generated by induction discharge. In this case, a secondary voltage as an output voltage of the ignition coil 21 is measured. When it is detected that the secondary voltage is not higher than the maximum voltage at capacitive discharge and is not higher than a determination voltage that is set higher than an average induction discharge voltage, it is determined that induction discharge is started. The determination voltage is for determining that, after becoming higher than the maximum discharge voltage at capacitive discharge, the secondary voltage drops to near the discharge voltage at induction discharge. Therefore, the determined timing for starting the induction discharge may come in the course of capacitive discharge not reaching the induction discharge. However, the secondary voltage is not higher than the determination voltage. Thus, even if a high-frequency voltage is superimposed on the voltage of capacitive discharge, no excessive voltage is generated. Therefore, the timing delay for turning on the switching means 28 is out of necessary until the spark discharge reaches induction discharge.

When it is determined at step S1 that induction discharge is started, the switching means 28 is controlled at step S2 to apply a pulsing flow obtained by subjecting a high-frequency voltage to half-wave rectification to the ignition plug 1. This generates a positive electric field.

With such a configuration, when an ignition signal output from the electronic controller 29 is input into the igniter of the ignition coil 21, a positive high voltage is applied from the secondary winding wire 21a of the ignition coil 21 to the center electrode 14 of the ignition plug 1. Thus, spark discharge is started. When spark discharge is started, a capacitive spark is first generated by capacitive discharge. After that, an induction spark is generated by induction discharge. Then, in response to the starting of the induction discharge, the switching means 28 is closed and a pulsing flow obtained by subjecting a high-frequency voltage to half-rectification is applied to the ignition plug 1.

In the embodiment, high-frequency wave from the high-frequency voltage generator 26 is subjected by the diode 23 to half-rectification into a positive pulsating current (voltage). The positive pulsating current is applied to the center electrode 14 to flow between the center electrode 14 and a ground electrode 42. Thus, an electric field is generated between the center electrode 14 and the ground electrode 15 at the time between an instant in the latter half of the capacitive discharge during the spark discharge and an instant immediately before the induction discharge or an instant at which the induction discharge is started. Then, a reaction takes place between the generated positive electric field and a product resulting from the spark discharge generated between the center electrode 14 and the ground electrode 15 to generate plasma and ignite an air-fuel mixture.

Specifically, the product resulting from the spark discharge by the ignition plug 1 becomes plasma in the electric field. As a result, the air-fuel mixture is ignited by the generated plasma. Thus, a flame core as start of flame propagation combustion becomes larger as compared to the case of ignition only by spark discharge. Further, a large number of radicals are generated within a predetermined space. This promotes combustion.

Specifically, a flow of electrons generated by the spark discharge and positive ions or radicals as a product resulting from the spark discharge vibrate or snake while moving away from the ignition plug 1 under influence of the positive electric field. This lengthens the stroke of the plasma ions or radicals. As a result, the number of collisions between the positive ions or radicals and water molecules or nitride molecules in the neighborhood increases exponentially. The water molecules or nitride molecules collided by the positive ions or radicals become OH radicals or N radicals. In addition, the surrounding gas collided by the positive ions or radicals enters into an ionized state (that is, plasma state). As a result, a region of ignition in the air-fuel mixture becomes larger exponentially. Further, the flame core as start of flame propagation combustion also becomes larger.

As described above, the positive ions or radicals generated after the ignition by capacitive discharge react with the positive electric field and repel the same. This facilitates the dispersion of plasma ions or the like. Therefore, it is possible to facilitate expansion of combustion and thus improve combustion efficiency.

In addition, the positive ions or radicals in plasma move in a direction of dispersion in the positive electric field. Thus, these positive ions or radicals do not include any factor inhibiting expansion of combustion. This eliminates the need to stop generation of an electric field in the process of expansion of combustion. Thus, high accuracy control of the timing for stopping application of a pulsing flow is out of necessary after the piston exceeds the top dead point. Thus, a program for the control can be simplified.

It is noted that the invention is not limited to the above-described embodiment.

In addition to the center electrode, an antenna for radiating high-frequency wave in the combustion chamber may be included in the cylinder head to generate a positive electric field. The antenna is preferably disposed near the center electrode and the ground electrode as much as possible.

Instead of the high-frequency voltage generator 26, a voltage generator that outputs a positive pulsating current changing at a frequency equivalent to the frequency of high-frequency wave may be provided. In this case, the diode 23 according to the above-described embodiment does not serve as a rectifier means but serves only as a backflow prevention means. At generation of an electric field, therefore, a positive pulsating current of high voltage output from the voltage generator can be lowered only for a drop in diode forward voltage. Consequently, energy taken for generation of an electric field can be reduced. In addition, heat generation from the diode 23 can be reduced. Heat loss can be therefore reduced.

The number of cylinders in the engine is not limited to that in the above-described embodiment.

The specific configuration of each component is not limited to that described in the embodiment, and can be modified in various manners without deviating from the gist of the invention.

The subject application is based on JP 2011-012776 filed by the applicant of the subject application in Japan on Jan. 25, 2011, the entire content of which is incorporated herein by reference.

### INDUSTRIAL APPLICABILITY

As an example, the invention is applied to a spark-ignited internal combustion engine that needs for ignition spark discharge by an ignition plug using gasoline or liquid natural gas as a fuel.

### DESCRIPTION OF REFERENCE SIGNS

1 Ignition plug
20 Ignition device
21 Ignition coil
26 High-frequency voltage generator
29 Electronic controller
100 Engine

1. A method for control of spark ignition in a spark-ignited internal combustion engine that includes an ignition plug and generates plasma to ignite an air-fuel mixture, where the plasma is caused by a reaction between a product resulting from spark discharge generated by a high voltage applied via an ignition coil connected to the ignition plug and an electric field generated in a combustion chamber by an electric generation means via the ignition plug, the method comprising:
generating the electric field by a positive pulsating current.
